(19) United States
(12) Patent Application Publication
(10) Pub. No.: US 2018/0060953 A1
(43) Pub. Date: Mar. 1, 2018

(54) Enterprise Sales Kit Creation System

(71) Applicant: SAP SE, Walldorf (DE)

(72) Inventor: Abraham Sasmito ADIBOWO, Singapore (SG)

(21) Appl. No.: 15/250,892

(22) Filed: Aug. 29, 2016

(51) Int. Cl. G06Q 40/02

(52) U.S. Cl. CPC G06Q 40/02

(57) ABSTRACT

A framework for pre-sales marketing professionals who perform engagements, such as business-to-business engagements. Embodiments of the claimed invention optimize early activities in the sales cycle. For each prospective engagement, the embodiments generate a sales kit that assists the salesperson in getting through the “beauty contest” phase of enterprise solutions sales, in which multiple vendors compete for a prospect's business. Embodiments also function as a repository for product teams to showcase products to the company's salespeople. In this way, product teams are enabled to engage salespeople to market their offerings, and salespeople are enabled to quickly prepare for initial meetings with sales prospects.

### BACKGROUND

Financial services companies and solutions companies have many products in their portfolios. Typically these companies perform high-touch business-to-business sales which involve providing a customized subset of these products that work together to form a solution.

When approaching a potential customer, a salesperson needs to present an optimized product mix tailored to the customer's needs. An investment banking account manager may recommend a set of instruments to finance a prospect company's growth plan. Similarly, an enterprise software salesperson may recommend a mix of middleware products, application packages, and support contracts to satisfy the prospect's information technology needs. Similar scenarios also exists in many other sales engagements.

The salesperson needs to make a good impression with the initial contact to get a foot in the door for subsequent engagements. Hence the salesperson needs to spend considerable time constructing these presentations. As this is typically a pre-sales activity in which the prospect is evaluating multiple vendors, there is a high chance of failure—the salesperson's company may not make a sale despite the enormous effort spent for the engagement.

Therefore, there is a need for an improved framework that addresses the abovementioned challenges.

### SUMMARY

Described is a system, method, and computer-implemented apparatus for pre-sales marketing professionals who perform engagements, such as business-to-business engagements. A salesperson spends considerable time preparing for such engagements, including:
finding the relevant products from a potentially massive internal product catalog;
finding the contact persons for these products and gathering information from product teams;
massaging the information to fit the prospect's needs; and
provisioning supporting materials for the prospect—samplers, data sheets, demonstrators, etc.

Embodiments of the claimed invention optimize early activities in the sales cycle. For each prospective engagement, the embodiments generate a sales kit that assists the salesperson in getting through the “beauty contest” phase of enterprise solutions sales, in which multiple vendors compete for a prospect's business.

Embodiments also function as a repository for product teams to showcase their products to the company's salespeople. In this way, product teams are enabled to engage salespeople to market their offerings.

A sales kit typically consists of, but is not limited to:
slideware—a presentation deck to be used by the salesperson for executive meetings;
pitch book—a hand-out version of the slideware containing more dense information;
demonstration videos;
trial accounts/product samplers/prototypes and
access to simulation systems.

In one embodiment, product owners (i.e., individuals or teams responsible for the development or production of a product) register their product(s) for inclusion in sales kits. Content creators, typically members of a product team, upload sales assets into the portfolio database, such as whitepapers, data sheets, one-slide summaries, demo software, 3-dimensional (3D) models, and the like. A salesperson then queries the portfolio database for matching products/services to create a solutions mix, selecting a product/service mix that is appropriate for his/her prospect, after which embodiments generate a customized sales kit based on the selected solutions mix.

The salesperson then utilizes the sales kit in a meeting with the prospect, e.g., presenting the solutions mix to the prospect's decision makers. Other levels of management at the prospect's organization may evaluate samples or demos. The salesperson receives feedback on the appropriateness of the solutions mix—expressly from the prospect or implicitly by making or not making the deal. If the solutions mix was not appropriate or otherwise not convincing enough to the prospect, the salesperson may select a different solutions mix as the basis of a different sales kit.

Once a sale has been made, and the sales cycle is complete, the salesperson gathers testimonials from the client about the solutions mix. These testimonials and success stores are recorded into the system as a case study for future sales engagements.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary architecture;

FIG. 2 illustrates one embodiment of an enterprise sales kit generating system; and

FIG. 3 is a flow chart illustrating one embodiment of generating a sales kit.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

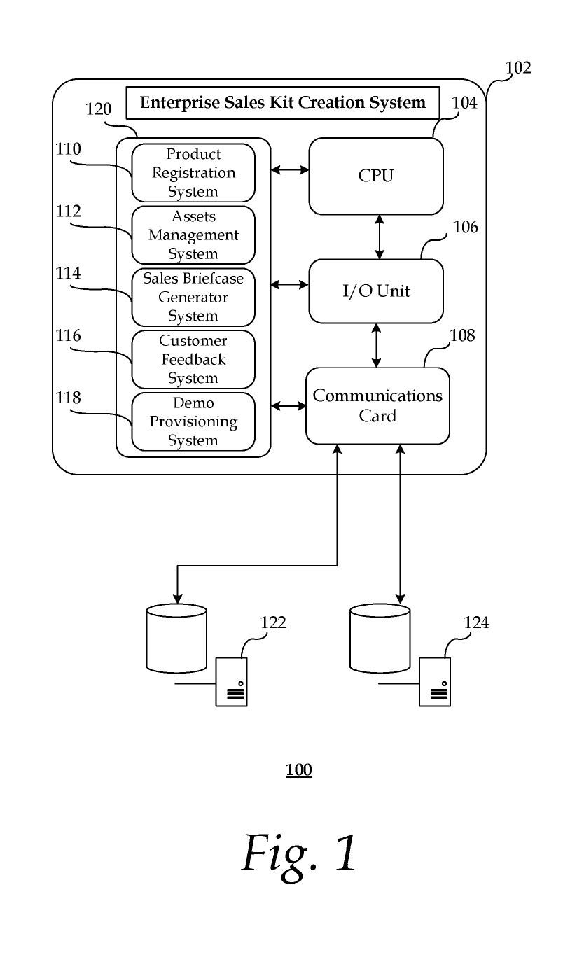

FIG. 1 is a block diagram illustrating an exemplary architecture 100 that may be used to implement generating a sales kit as described herein. Generally, architecture 100 may include a sales kit generating system 102, a portfolio database 122, and a customer database 124.

The sales kit generating system 102 can be any type of computing device capable of responding to and executing instructions in a defined manner, such as a workstation, a server, a portable laptop computer, another portable device, a touch-based tablet, a smart phone, a mini-computer, a mainframe computer, a storage system, a dedicated digital appliance, a device, a component, other equipment, or a combination of these. The system may include a central processing unit (CPU) 104, an input/output (I/O) unit 106, a memory module 120 and a communications card or device 108 (e.g., modem and/or network adapter) for exchanging data with a network (e.g., local area network (LAN) or a wide area network (WAN)). It should be appreciated that the different components and sub-components of the system may be located on different machines or systems. Memory module 120 may include product registration system 110, assets management system 112, sales briefcase generator system 114, customer feedback system 116, and demo provisioning system 118.

The sales kit generating system 102 may be communicatively coupled to one or more other computer systems or devices via the network. For instance, the system may further be communicatively coupled to one or more data repositories, such as portfolio database 122 or customer database 124. The portfolio database 122 and/or the customer database 124 may be, for example, any database (e.g., relational database, in-memory database, object database, NoSQL database, etc.). The portfolio database 122 and/or the customer database 124 may also be referred to as a catalog, and may contain tables, views, stored procedures, indexes, full-text indexes, and the like.

Project registration system 110 includes logic for receiving and processing user input for the purpose of generating a sales kit. In one embodiment project registration system 110 encompasses one or more of assets management system 112, sales briefcase generator system 114, customer feedback system 116, and/or demo provisioning system 118. However, each of these modules may operate independently, on the same or different computing devices as each other.

In one embodiment, product registration system 110 receives a product registration that includes data, e.g., properties, associated with one or more products that are available to be described in a sales kit. A product is any physical object made available for sale, lease, or rent to a customer, as well as software made available by a physical media or download. The properties identify the one or more products, describe the one or more products, indicate what other products may be related and potentially synergistic, and/or indicate what markets/customers/industries the product is relevant to.

In one embodiment, the product comprises a service, such as a web service, cloud service, delivery service, or any other type of offering that is not a physical product or locally installed software product. Any operation performed by product registration system 110 with regard to a product may similarly be performed with regard to a service. Product registration system 110 may associate products and services, or create combinations of products and services.

In one embodiment the product registration may be received from a product group responsible for development and/or production of the product. In this way, product availability is made known to salesperson for inclusion in a sales kit. However, product registration may be received from a salesperson, customer, or any other source. Once received, the product registration is stored in portfolio database 122.

Assets management system 112 includes logic for, in response to receiving a sales asset registration, storing the sales asset registration in the portfolio database. A sales asset, in one embodiment, includes a slide deck, e.g., a PowerPoint® presentation, a whitepaper, a datasheet, and/or a product video. Additionally or alternatively, the sales asset may include a demo (i.e., demonstration), a demonstration video, a product sample, or a mini-replica (i.e., a miniature version of a product). In one embodiment a sales asset is associated with (e.g., refers to) a single product, but it is also contemplated that a sales asset describes or is otherwise associated with multiple products and/or services, combinations of products and/or services, and the like.

Sales briefcase generator system 114, in one embodiment, receives a product query and generates a sales kit containing one or more products, services, and or sale assets appropriate for a sales prospect. In one embodiment the product query includes attributes of the sales prospect, and the query is executed on the portfolio database 122, returning matching products, services, and/or sales assets based on the attributes included in the query and the properties of the products, services, and sales assets stored in portfolio database 122. Additionally or alternatively, sales briefcase generator system 114 queries customer database 124, which stores customer feedback, demographic information, and other properties associated with a sales prospect, company, industry, or the like. While depicted separately, portfolio database 122 and customer database 124 may be combined and implemented on a single database.

Sales briefcase generator system 114 may present query results to a user, and in turn receive a selection from the user of one or more products, services, and/or sales assets for inclusion in a sales kit. In this way, refinement by the salesperson enables a customized sales kit to be created. A salesperson may also be enabled to select some but not all of the returned query-returned material related to a product for inclusion in the sales kit.

Once the products, services, and sales assets have been selected, sales briefcase generator system 114 employs demo provisioning system 118 to create the sales kit. Demo provisioning system 118 may employ a printer, a 3-dimensional (3D) printer, a computer numerical control system, simulation software, demonstration software, and the like.

Customer feedback system 116, in one embodiment, receives feedback from sales prospects, either implicitly by an indication that a sale was made or not, or expressly, in the case of surveys, notes captured by the salesperson, or the like. In one embodiment, customer feedback system 116 stores this information in customer database 124. Customer feedback may be distilled into attributes associated with a customer, such that subsequent queries will match products to the customer according to the feedback.

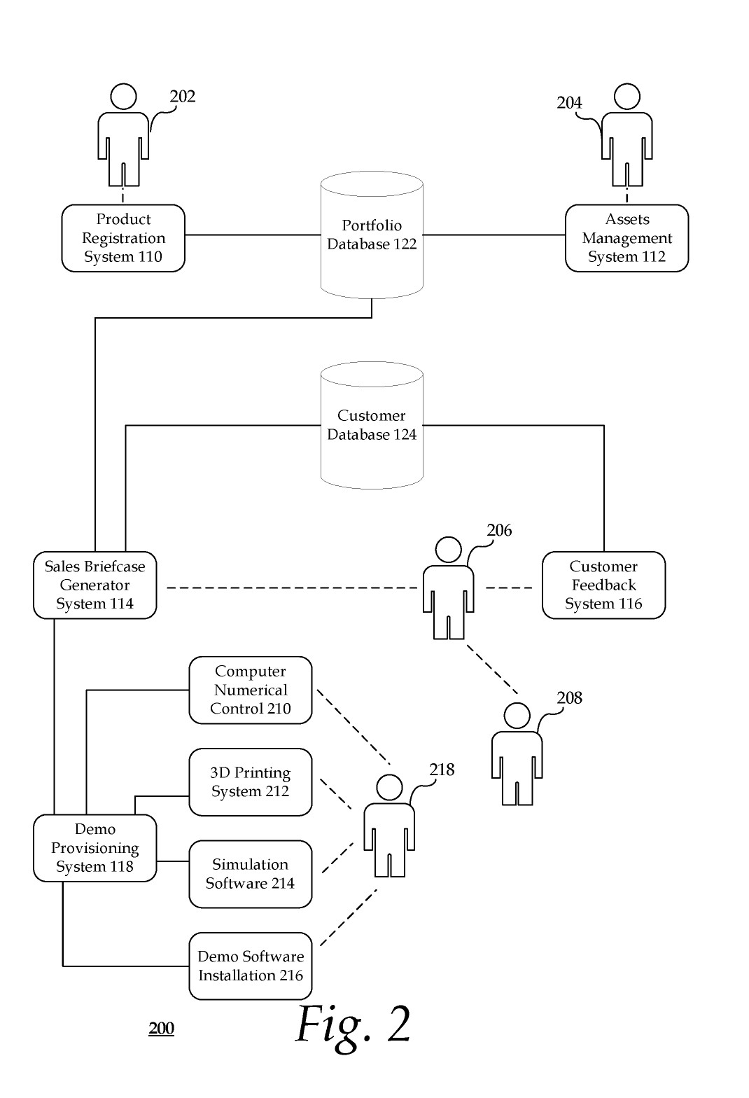

FIG. 2 illustrates one embodiment 200 of an enterprise sales kit generating system. FIG. 2 depicts, corresponding to FIG. 1, product registration system 110, assets management system 112, sales briefcase generator system 114, customer feedback system 116, and demo provisioning system 118, as well as portfolio database 122 and customer database 124. FIG. 2 also depicts product owner 202, stakeholder 204, salesperson 206, sales prospect executive 208, and other prospect stakeholders 218.

Product owner 202 interacts with product registration system 110 to register a product, including uploading a description of the product, indicating properties about the product such as cost, industry, time to market, related products, and the like. In one embodiment, in addition to these properties, images, descriptions, videos, or other means of describing the product are similarly received. The product description/properties are then, in one embodiment, stored in portfolio database 122.

Stakeholder 204 interacts with assets management system 112 to register a sales asset. As indicated above, a sales asset may include any documentation such as a slide deck, a whitepaper, a datasheet, a product video, or the like. Stakeholder 204 may be a technical writer, product manager, executive, or anyone else with expertise about a given product. The sales asset is then stored in portfolio database 122.

Salesperson 206 interacts with sales briefcase generator system 114 (also known as a sales kit generator system) to generate a sales kit. Sales briefcase generator system 114 receives a query from salesperson 206 requesting information related to a sales prospect. The query may contain information about the industry the sales prospect operates in, information about preferences that sales prospect executive 208 is known to have, information about what other products and services the sales prospect has already purchased, and the like. Sales briefcase generator system 114 may query one or both of portfolio database 122 and customer database 124 in order to return one or more products, services, and/or sales assets to be incorporated in the sales kit.

In one embodiment, sales briefcase generator system 114 automatically selects a collection of products, services and/or sales assets to include in a sales kit. However, in another embodiment, salesperson 206 is presented with a list of products, services, and sales assets from which to choose from. In either case, sales briefcase generator system 114 utilizes computer numerical control (CNC) machine 210, 3D printing system 212, simulation software 214, and demo software installation 216 to produce the physical products included in the sales kit, and for setting up any software/cloud services to be made accessible to the recipient of the sales kit. In one embodiment, prospect stakeholder 218 may be presented with any or all of the outputs of CNC machine 210, such as a sample of the product, 3D printing system 212, such as a model/prototype of the product, simulation software 214 enabling a simulation of the product or service to be run, and demo software installation 216, enabling a demonstration of the product to be performed.

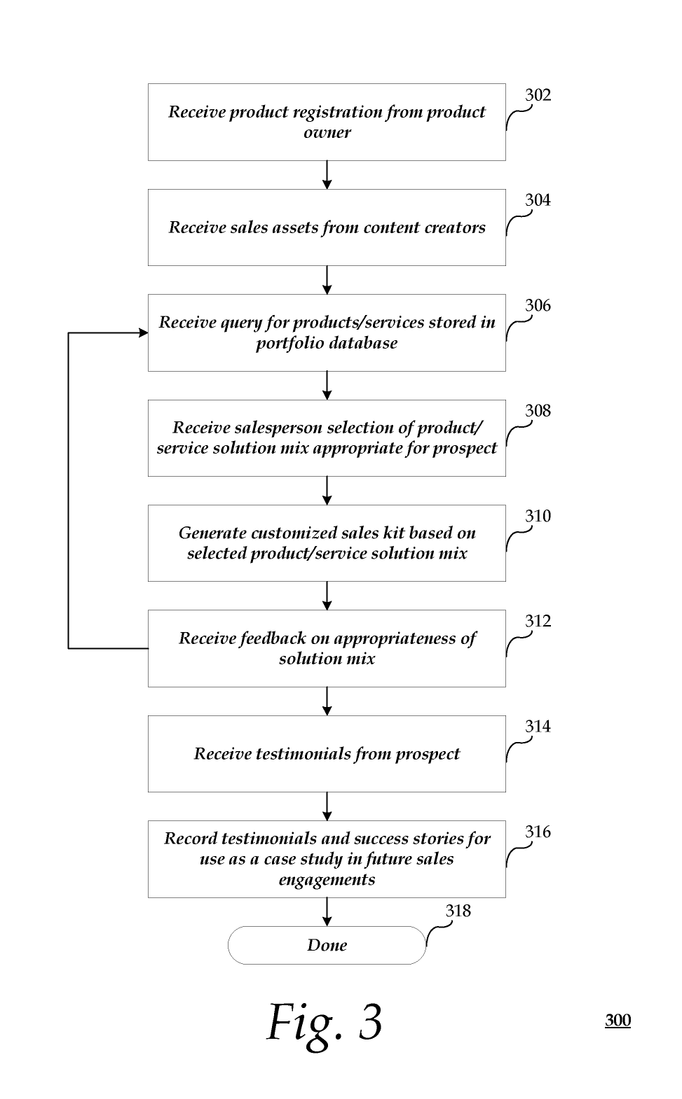

FIG. 3 is a flow chart 300 illustrating one embodiment of an enterprise sales kit generating system. The process may be performed automatically or semi-automatically by the sales kit generating system 102, described above with reference to FIG. 1.

At block 302, a product registration is received from a product owner. The product registration may include properties about the product such as cost, industry, time to market, related products, and the like. For example, a product manager for a financial services group could register a service for managing a company's 401k plan, or a team lead of a power generator manufacturer could register an alternator used in a hydroelectric dam. The product registrations are then stored in portfolio database 122.

At block 304, sales assets are received from stakeholders, including one or more of a slide deck, a whitepaper, a datasheet, a product video, or the like. For example, a finance expert associated with the financial services group may register a whitepaper describing the money management philosophy of the 401k management service, or a safety engineer of the power generator manufacturer registers a video advertising safety features of the new alternator. The sales assets are then stored in portfolio database 122.

At block 306, a query for products and/or services is received. In one embodiment the query is performed across the portfolio database 122 and customer database 124. For example, a query for retirement management services might return the 401k management service registered by the financial services group, while a query for power generation could return the registered alternator. Furthermore, if customer information about the sales prospect, such as whether a similar product/service/sales asset was contained in a sales kit that was previously successful (either with the prospect's company or a competitor), such an indication may be retrieved from customer database 124 and incorporated in ranking and selecting products/services/sales assets for inclusion.

At block 308, salesperson 206 optionally receives one or more results of the query, and is enabled to select from the results to create a solution mix customized for the sales prospect.

At block 310, a customized sales kit is generated based on the selected product/service/sales asset solution mix selected by salesperson 206. For example, demo provisioning system 118 may request a printout of the whitepaper describing the money management philosophy of the financial services group. Similarly, demo provisioning system 118 may request 3D printing system 212 to generate a model of the alternator. In this way, salesperson 206 is enabled to quickly prepare for a meeting with sales prospect stakeholder 208.

At block 312, feedback is received of the appropriateness of the solution mix. For example, if the sales prospect of the 401k management product liked the presentation and purchased the service, the success of the whitepaper on money management philosophy would be stored in the portfolio database 122. However, if the sales prospect of the alternator went with a competitor, an indication that this particular sales prospect was not persuaded by the 3D model would be noted in customer database 124. Similarly, an indication that the 3D model was not persuasive would be stored in portfolio database 122 as a property of the alternator. During subsequent processing of subsequent queries, attributes such as these would be considered, thereby enhancing the salesperson's chances of success.

At block 314, testimonials are received from a sales prospect when the sale has been made. For example, the executive who decided to purchase the 401k management service could be surveyed to find out which aspect of the sales kit were most effective. This information is then stored in the portfolio database 122, indicating the success of the selected products/services/sales assets, as well as being stored in customer database 124, indicating the preferences of the purchasing executive.

At block 316, testimonials and success stories are used as a case study in future sales engagements where similar products/services/sales assets are considered for inclusion in a sales kit.

At block 318, the process 300 ends.

What is claimed is:

1. A computer-implemented method of generating a sales kit, comprising:
receiving a product registration;
storing the product registration in a portfolio database;
receiving a product query of the portfolio database, wherein the product query is based on an attribute of a sales prospect;
receiving a selection of one or more products returned from the product query; and
generating the sales kit based on the selection of the one or more products.

2. The computer-implemented method of claim 1, wherein the product registration is received from a product team and includes one or more properties associated with a product.

3. The computer-implemented method of claim 1, further comprising:
receiving a sales asset registration; and
storing the sales asset registration in the portfolio database, wherein the product query includes a sales asset query, and wherein the selection of the one or more products includes a selection of one or more sales assets.

4. The computer-implemented method of claim 3, wherein the sales asset includes a slide deck, a whitepaper, a datasheet, or a product video.

5. The computer-implemented method of claim 3, wherein the sales asset includes a demo, a product sample, or a mini-replica.

6. The computer-implemented method of claim 1, further comprising:
receiving feedback indicating an appropriateness of the selection of the one or more products included in the sales kit;
storing the feedback in the portfolio database; and
incorporating the feedback in a subsequent query of the portfolio database.

7. The computer-implemented method of claim 6, wherein the feedback is received from a stakeholder of the sales prospect.

8. The computer-implemented method of claim 1, wherein generating the sales kit includes provisioning a demo from a demo provisioning system.

9. The computer-implemented method of claim 8, wherein the demo provisioning system provides a demo software installation enabling a sales prospect stakeholder to use a demonstration of the product, a simulation software enabling a sales prospect stakeholder to run a simulation of the product, a 3D printing system enabling a sales prospect stakeholder to obtain a model of the product, or a computer numerical control enabling a sales prospect stakeholder to obtain a sample of the product.

10. A computing apparatus facilitating generating a sales kit, the computing apparatus comprising:
a processor; and
a memory storing instructions that, when executed by the processor, configures the apparatus to:
receive a product registration,
store the product registration in a portfolio database,
receive a product query of the portfolio database, wherein the product query is based on an attribute of a sales prospect,
receive a selection of one or more products returned from product the query, and
generate the sales kit based on the selection of the one or more products.

11. The computing apparatus of claim 10, wherein the sales kit includes one or more of: a slide deck, a whitepaper, a data sheet, a product video, a demonstration system, a product sample, or a mini-replica.

12. The computing apparatus of claim 10, wherein the memory stores additional instructions that, when executed by the processor, configures the apparatus to:
receive feedback from a stakeholder indicating an appropriateness of the selection of the one or more products included in the sales kit;
store the feedback in the portfolio database; and
incorporate the feedback in a subsequent query of the portfolio database.

13. The computing apparatus of claim 12, wherein the feedback is based on an evaluation of a product data sheet.

14. The computing apparatus of claim 12, wherein the feedback is based on a line manager evaluation of a product sample or demo system.

15. The computing apparatus of claim 12, wherein the feedback is received when a sale has been made to the sales prospect, the feedback including a testimonial from the sales prospect.

16. The computing apparatus of claim 15, wherein the feedback is recorded as a case study, and wherein a subsequent product query returns subsequent products based on the case study indicating that the one or more products were presented during a sales engagement that resulted in the sale being made to the sales prospect.

17. A non-transitory computer-readable storage medium facilitating archiving of database index data, the computer-readable storage medium including instructions that when executed by a computer, cause the computer to:
receive a product registration;
store the product registration in a portfolio database;
receive a product query of the portfolio database, wherein the product query is based on an attribute of a sales prospect;
receive a selection of one or more products returned from product the query; and
generate the sales kit based on the selection of the one or more products.

18. The non-transitory computer-readable storage medium of claim 17, wherein the product registration is received from a product team and includes one or more properties associated with a product, and wherein the product query returns products based on a comparison between the one or more properties and the attribute of the sales prospect.

19. The non-transitory computer-readable storage medium of claim 17, wherein the computer-readable storage medium includes additional instructions that when executed by the computer cause the computer to:
receive feedback indicating an appropriateness of the selection of the one or more products included in the sales kit;
store the feedback in the portfolio database; and
incorporate the feedback in a subsequent query of the portfolio database.

20. The non-transitory computer-readable storage medium of claim 17, wherein generating the sales kit includes provisioning a demo provisioning system which provides a demo software installation enabling a sales prospect stakeholder to use a demonstration of the product, a simulation software enabling a sales prospect stakeholder to run a simulation of the product, a 3D printing system enabling a sales prospect stakeholder to obtain a model of the product, or a computer numerical control enabling a sales prospect stakeholder to obtain a sample of the product.
